(19) United States
(12) Patent Application Publication
(10) Pub. No.: US 2025/0347358 A1
(43) Pub. Date: Nov. 13, 2025

(54) VISUAL IDENTIFICATION OF STATUS OF STORAGE CONTAINER VALVE

(71) Applicant: ECOLAB USA INC., Saint Paul, MN (US)

(72) Inventor: Jordan Russo, Saint Paul, MN (US)

(21) Appl. No.: 19/200,219

(22) Filed: May 6, 2025

Related U.S. Application Data
(60) Provisional application No. 63/643,632, filed on May 7, 2024.

(51) Int. Cl. F16K 37/00; B65D 47/20

(52) U.S. Cl. CPC F16K 37/0058; B65D 47/20

(57) ABSTRACT

Containers are used to hold and even ship items, such as fluids. In such containers, there is often a valve that can be used to off let pressure or even dispense the fluid from the container. The location of the valve is at the bottom, making it difficult to check to make sure if it is closed, such as for filling and/or transport. A color-coded locking apparatus can be placed on the valve to provide quick and accurate assessment of the valve. The apparatus is designed to fit one way when the valve is open, and the other way when the valve is closed, making it reliable for use.

### CROSS REFERENCE TO RELATED APPLICATIONS

This application claims priority under 35 U.S.C. § 119 (e) to provisional patent application U.S. Ser. No. 63/643,632, filed May 7, 2024. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to an apparatus for use with portable or permanent containers. More particularly, but not exclusively, the present disclosure relates to a visual device that can be added to containers to provide instant identification as to the status of a valve of the container, such as if it is open or closed.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Containers are often used to store and/or transport fluids. For example, portable containers can be used to transport fluids from one location to another. More permanent containers can be used to store the fluids at a location. Some of the containers can be rather large, for example holding 200-400 gallons of fluid that can then be shipped to another location. These containers may comprise steel.

Some portable containers are shipped with an open valve. Other times the valve is to be closed. For safety reasons, the valve should be closed during shipping. However, with some of these containers, the valve is located at a position where it is not easily known if the valve is open or closed. This is not ideal, as the containers may be filled with an open valve, which would leak the fluid being added to the container.

Thus, there exists a need in the art for an apparatus which provides clear and easy indication as to the status of a valve of a container, which is reliable and noticeable from a distance.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of any aspect of any embodiment of the present disclosure to improve on or overcome the deficiencies in the art.

It is a further object, feature, and/or advantage of any aspect of any embodiment of the present disclosure to provide a reliable, visual indication as to the opened or closed status of a valve of a liquid container. For example, the apparatus can provide the status from a distance to certify the status of the valve.

It is still yet a further object, feature, and/or advantage of any aspect of any embodiment of the present disclosure to be a secondary check to mitigate shipping an open container.

It is yet another object, feature, and/or advantage of any aspect of any embodiment of the present disclosure to mitigate loss of containment of a container, such as by filling a container that has an opened valve.

The apparatus disclosed herein can be used in a wide variety of applications. For example, many different containers are used to hold and/or ship a fluid, and the apparatus could be used with any container that includes a valve.

It is preferred that the apparatus be safe, cost effective, and durable.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the apparatus. The aesthetic also allows for quick and accurate assessment as to the status of a valve of a container.

Methods can be practiced which facilitate use, manufacture, assembly, maintenance, and repair of an apparatus which accomplish some or all of the previously stated objectives.

The apparatus can be incorporated into systems [or kits] which accomplish some or all of the previously stated objectives.

According to some aspects of the present disclosure, a visual apparatus for indicting if a valve of a container is open or closed comprises a cylindrical body having a first portion having a first outer diameter and a second portion extending from the first portion and having a second outer diameter; wherein the first outer diameter is less than the second outer diameter; and wherein the second portion of the cylindrical body is unable to be positioned on the valve of the container when the valve is open.

According to at least some aspects of at least some embodiments, the first portion faces outward from the container when the valve of the container is closed.

According to at least some aspects of at least some embodiments, the second portion faces outward from the container when the valve of the container is open.

According to at least some aspects of at least some embodiments, the first portion comprises a first color, and at least a face of the second portion comprises a second color.

According to at least some aspects of at least some embodiments, the face and an outer portion of the second portion comprise the second color.

According to at least some aspects of at least some embodiments, the second color comprises red.

According to at least some aspects of at least some embodiments, the first and second portions of the cylindrical body comprise a common inner diameter.

According to at least some aspects of at least some embodiments, the first and second portions are coaxial.

According to at least some aspects of at least some embodiments, the cylindrical body comprises a rigid polymer.

According to additional aspects of the disclosure, in combination, a container and a visual apparatus comprise that the container comprising a body for holding a liquid and a drain valve that is used to drain liquid from the container, the valve comprising an arm to open and close the valve; and the visual apparatus comprising a cylindrical body having a first portion having a first outer diameter and a second portion extending from the first portion and having a second outer diameter; wherein the first outer diameter is less than the second outer diameter; and wherein the second portion of the cylindrical body is unable to be positioned on the valve of the container when the valve is open.

According to at least some aspects of at least some embodiments, the first portion of the visual apparatus faces outward from the container when the valve of the container is closed.

According to at least some aspects of at least some embodiments, the second portion of the visual apparatus faces outward from the container when the valve of the container is open.

According to at least some aspects of at least some embodiments, the first portion of the visual apparatus comprises a first color, and at least a face of the second portion of the visual apparatus comprises a second color.

According to at least some aspects of at least some embodiments, the second color comprises red.

According to at least some aspects of at least some embodiments, the first and second portions of the cylindrical body comprise a common inner diameter.

According to at least some aspects of at least some embodiments, the first and second portions are coaxial.

According to additional aspects of the disclosure a method of providing a visual determination as to the status of a valve of a container comprises positioning a visual apparatus on the valve, wherein the visual apparatus comprises a cylindrical body having a first portion having a first outer diameter and a second portion extending from the first portion and having a second outer diameter; wherein the visual apparatus fits on the valve with the second portion facing away from the valve when the valve is open and wherein the visual apparatus fits on the valve with the first portion facing away from the valve when the valve is closed.

According to at least some aspects of at least some embodiments, the second portion of the visual apparatus comprises a different color than the first portion.

According to at least some aspects of at least some embodiments, the color viewed indicates the status of the valve of the container.

According to at least some aspects of at least some embodiments, the step of positioning the visual apparatus on the valve comprises moving the visual apparatus around the valve with the portion of the visual apparatus determined by the position of an arm of the valve.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows an example of a container or tank that can be used to hold an amount of fluid and showing a valve in an open configuration.

FIG. 2 is similar to FIG. 1 but shows the valve in a closed configuration.

FIG. 3 is a close up view of the outlet and valve of a container and showing an example of a visual apparatus to indicate if the valve is opened or closed.

FIG. 4 is another view of the outlet and shows how the visual apparatus will not be able to be positioned on the outlet with the wider portion facing the outlet due to the position of the valve in the open configuration.

FIG. 5 is a view showing a visual apparatus on the outlet and providing indication that the valve is in the open configuration.

FIG. 6 is a view of the container with the visual apparatus indicating that the valve is in the closed configuration.

FIG. 7 is a view of a plurality of containers with visual apparatus indicating that some of the valves are open and some of the valves are closed.

FIG. 8 is a perspective view of a visual apparatus according to at least some embodiments of the present disclosure.

FIG. 9 is a side elevation view of the visual apparatus of FIG. 8.

FIG. 10 is a sectional view of the visual apparatus of FIG. 8.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

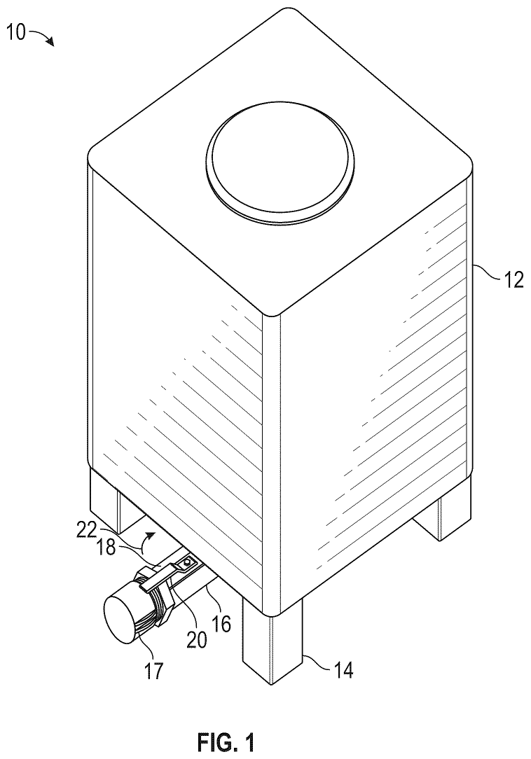

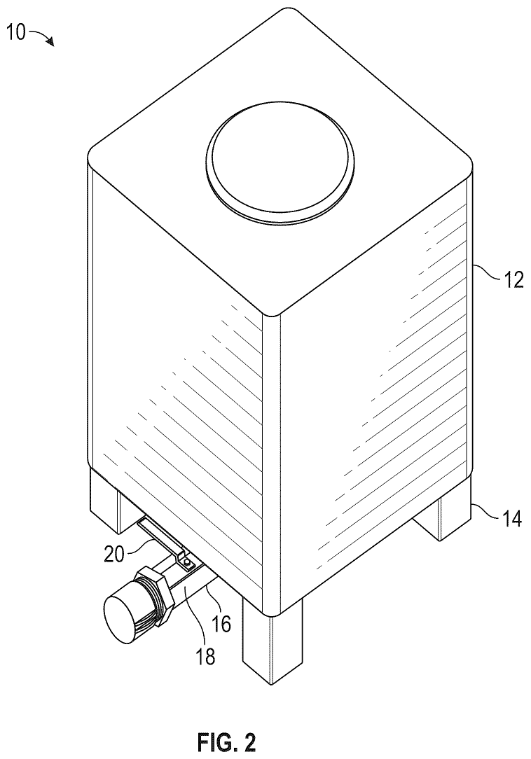

Portable containers, such as the container 10 shown in FIGS. 1 and 2, are often used to ship liquids, such as chemicals. The containers 10 can be shipped from a manufacturer and prefilled with the desired liquid in the desired amount, making it easy to keep supplies moving to and from a place of use. As shown in the example container 10 in the figures, the container 10 comprises a body or housing 12, which is the portion of the container that holds the liquid. While the liquid can be a chemical liquid, it should be noted that generally any liquid needing shipped can be considered.

Additionally, the container is shown to have legs 14 to support the container housing 12. A drain outlet 16 extends from a bottom portion of the container housing 14. However, it should also be appreciated that the container does not need legs in all forms, and the drain outlet 16 could extend from a lower portion of one of the sides of the housing. However, the lower location of the drain outlet allows for gravity to move the liquid from within the container housing for dispensing of the same.

To control the output of the liquid from the container, the outlet 16 will often include a valve 18 (or other flow control device) and/or a lid 17. A valve is a device or natural object that regulates, directs, or controls the flow of a fluid (gases, liquids, fluidized solids, or slurries) by opening, closing, or partially obstructing various passageways. For example, the valve 16 could be a cam lock valve or valve with camlock fitting to control the flow of the liquid from within the container to outside the container via the outlet 16. As noted, a lid 17 could be fitted at the valve outlet as well.

To operate the valve 18, an arm or handle 20 can be rotated between open and closed configurations. For example, as shown in FIG. 1, the valve handle 20 is in an open configuration (extending in line with the outlet 16). In such a configuration, the valve is open and liquid is able to move through the valve and outlet from the container.

However, as shown in FIG. 2, the valve handle 20 has been rotated (see arrow 22 in FIG. 1) approximately 90-degrees to close the valve 18. In such a configuration, the passage through the valve 18 and thus, the outlet 16, is closed off such that no liquid is able to pass through and out of the container or outlet.

It is important to know the status of the valve 18 (i.e., open or closed), as liquid can be wasted if the container is filled with the valve open and the liquid is dispensed out of the outlet 16. In addition, if the liquid is a chemical, this could have detrimental effects on people and/or the environment, in addition to being a costly waste of the material.

The portable containers 10 can unintentionally be shipped with an open valve and the valve is not inspected prior to use. If shipped to a customer, the liquid could come rushing out of the container. If back to the supplier, the container could be filled with an open valve, increasing the chance of spillage. The only current way to check the status of the valve is to manually inspect the valve. This requires in person review and identification of the valve, such as the valve arm 20. This takes time and is not ergonomically safe, as the valve can be at the underside of the container.

Therefore, the present disclosure provides a visual apparatus 30 that provides visual indication as to the status of a valve of a container, such as those shown in the figures. The visual apparatus 30 provides the benefits of providing quick and reliable information in the form of valve status to provide a secondary check to mitigate issues related to open valves and containers.

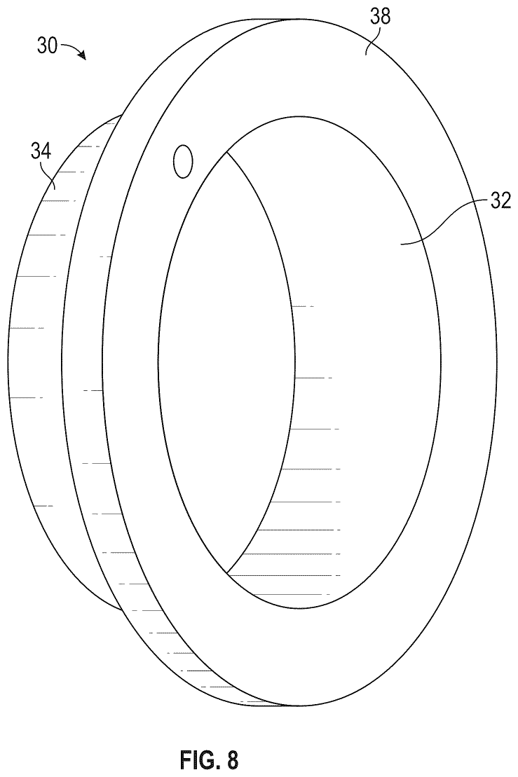

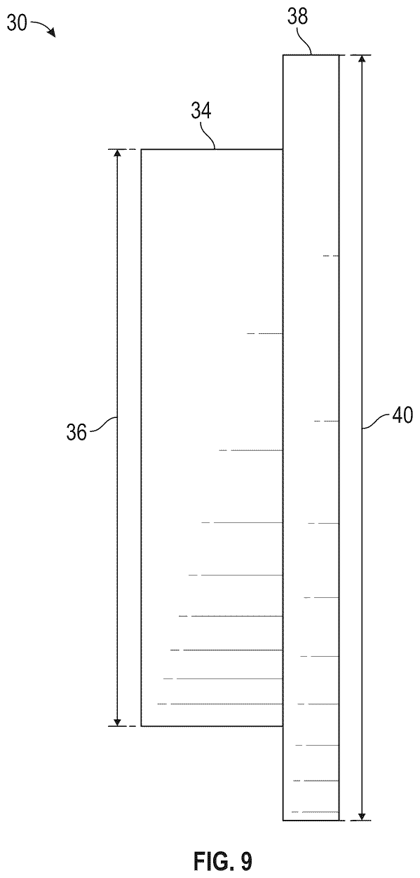

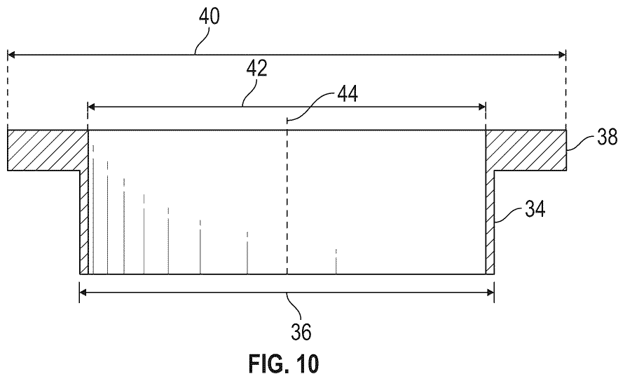

A visual apparatus 30 according to at least some embodiments is shown in FIGS. 8-10. As shown, the apparatus 30 generally comprises a cylindrical body 32 with a first portion 34 and a second portion 38 that are coaxial with one another. The first portion 34 is cylindrical and has a first portion outer diameter 36 (see, e.g., FIGS. 9 and 10).

The second portion 38 is connected to the first portion 34 and extends therefrom and has a second portion outer diameter 40, which is shown to be greater than the first portion outer diameter 36 (see, e.g., FIGS. 9 and 10). Therefore, the second portion 38 forms a kind of flange member extending from an end of the first portion 34.

FIG. 10 shows additional aspects of the visual apparatus. For example, it is shown that the inner diameters of both the first and second portions 34, 38 are substantially similar. In addition, the figure shows the axis 44 of the device, showing that the portions are coaxial with one another.

The thickness of the portions of the apparatus 30 are not to be limiting on the disclosure. For example, while it is shown that the first portion thickness is less than that of the second portion, it should be appreciated that this could be reversed or that both portions could have the same or substantially the same thickness.

In addition, it should be noted that the visual apparatus 30 comprise a polymer, which could be a plastic or rubber polymer. It should be noted that the material composition of the apparatus 30 is not to be limiting on the disclosure, and that generally any material capable of holding up the components should be considered to be a part of the disclosure.

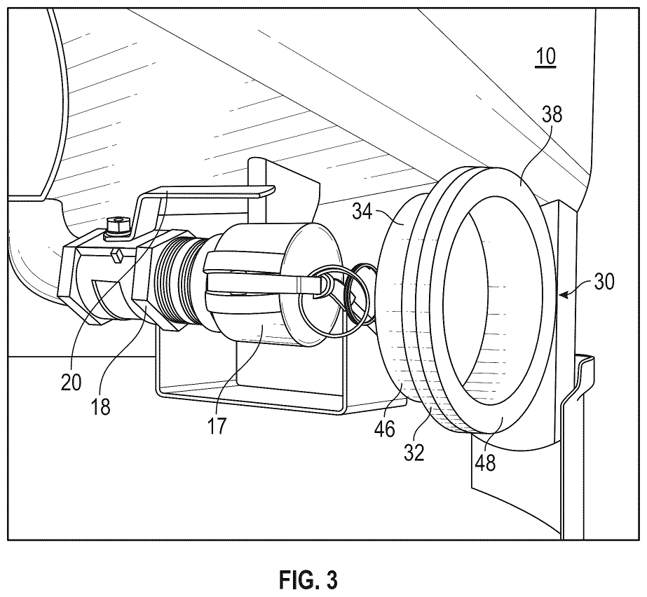

Moving back to FIG. 3, an example use and benefits of the visual apparatus 30 with a container system as has been included is shown. As shown in FIG. 3, the container 10 includes an outlet 16 that includes a valve 18 and cam lock casing. There is also a lid 17 on the cam lock. The valve handle 20 is shown in line with the outlet 16, which means that the valve 18 is in the open configuration. Also note that the valve handle 20 is at least partially under a portion of the container body 12, making it difficult to view to see the status.

Also note that the visual apparatus 30 (spaced away from the valve in the figure for ease of visualization) is oriented in such a way that will only allow the visual apparatus 30 to fit one way, which allows for easy use of the apparatus 30. For example, as noted, the first portion 34 of the apparatus 30 has an outer diameter that is less than that of the second portion 38. The outer diameter 36 of the first portion 34 is sized such that the first portion can fit between the valve handle 20 and the outlet/lid/valve/fitting when the valve is in the open configuration to position the apparatus 30 on the container with the second portion 38 of the apparatus outward facing.

Also note in FIG. 3 that the apparatus 30 can be color coded for visual information. The first portion 34 is a first color 46 (e.g., blue) and the second portion 38 can include a portion, such as the front face, which is a second color 48 (e.g., red). The different colors will provide a quick and accurate indication as to which portion of the apparatus is faced away from the container, which provides the quick and accurate indication as to the status of the valve (i.e., open or closed). The use of color with the different sized portions also allows the visual appearance to be seen from a distance, which saves time while making sure that an accurate indication has been provided.

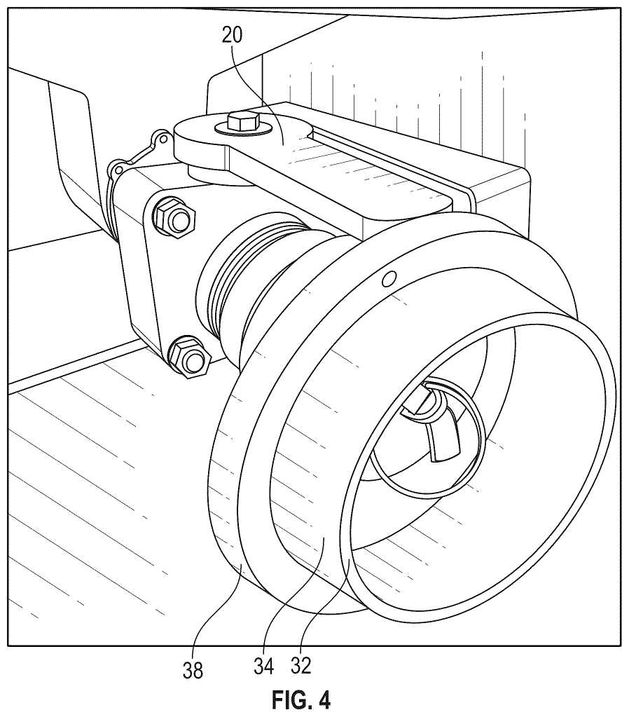

As shown in FIG. 4, when the valve handle 20 is in the open configuration, the outer diameter 40 of the second portion 38 of the apparatus 30 is too large to mount on the outlet, such as between the outlet drain and the handle 20. This essentially creates a situation where there is less opportunity or chance that a visual apparatus 30 could be oriented in the incorrect direction. In other words, this mitigates the possibility that the apparatus would indicate a closed configuration when it is really open. For example, this prevents the second color 48 being shown away from the container. Thus, the simple but accurate visual apparatus also reduces the likelihood of error.

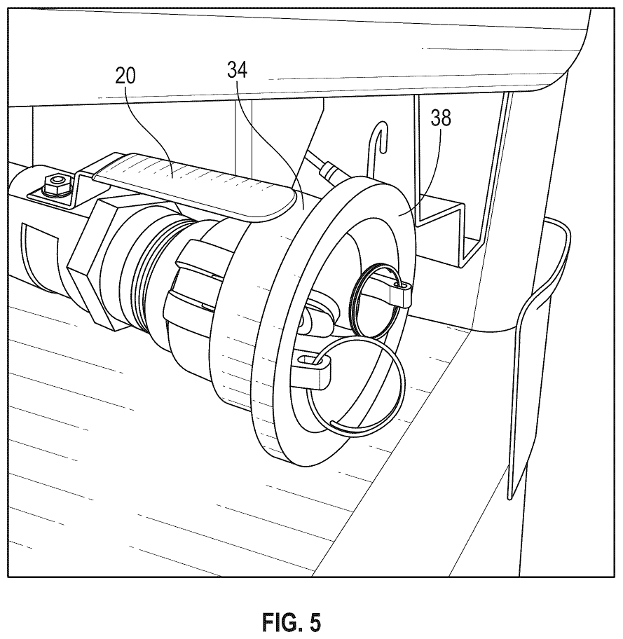

Therefore, the proper and correct mounting of an apparatus 30 on a drain outlet 16 of a container showing an open valve is shown in FIG. 5. As noted, the handle 20 is in the open configuration, which only allows for the smaller outer diameter of the first portion 34 of the apparatus 30 to fit between the handle 20 and the outlet 16. In such a configuration, the second color 48 (e.g., red) of the second portion 38 is facing away from the container 10, which would provide quick and accurate information to indicate the openness of the valve. This will mitigate issues, such as potential spilling, and would ensure that the valve is closed before any addition of liquid is added to the container.

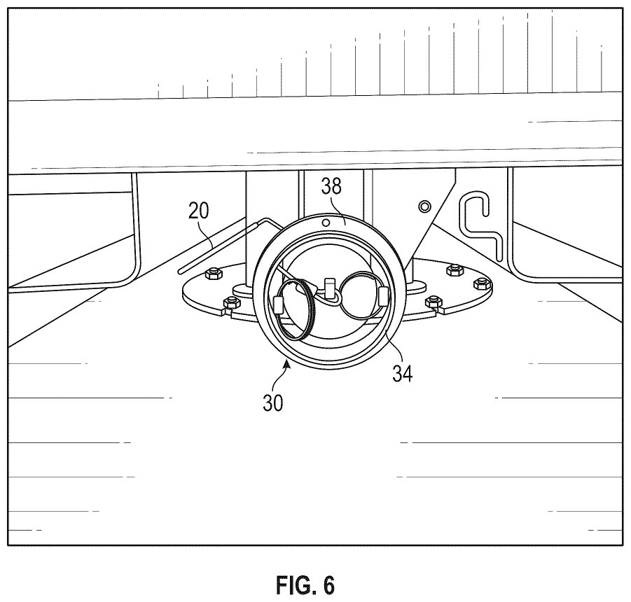

FIG. 6 shows the placement of an apparatus 30 on a drain valve of a container indicating that the valve 18 is closed. As is shown in the figure, the valve handle 20 has been rotated to the closed configuration, which moves the handle from being generally in line with the drain. According to some valves, this may be a full or approximately 90-degrees. However much movement, the handle 20 is now out of the way and the larger diameter second portion 38 of the apparatus can be the leading face for adding the apparatus. Thus, a viewer would see the first portion 34 of the apparatus, which can provide the accurate information that the valve is closed. The first portion 34 can also include the coloring of the first color 46 (e.g., blue) to provide additional indication that the valve is in the closed configuration.

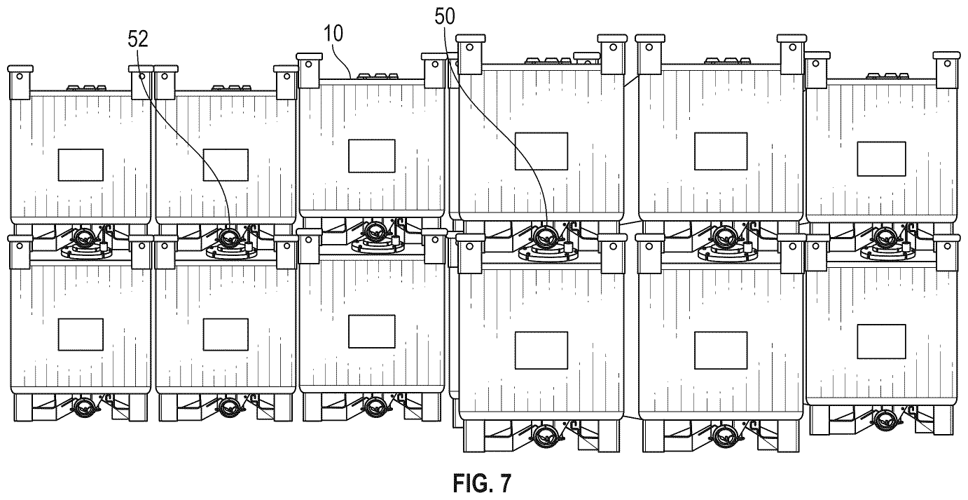

Providing such information in a quick and accurate visual manner provides numerous advantages and/or benefits. As shown in FIG. 7, a number of containers 10 may be stored together for future use. Each of the containers includes a visual apparatus, such as shown and described herein, which provide quick and accurate information as to the status of the valves on the containers. In the figure, the six left containers show the first color 46, which provides visual confirmation that the valves for these six are all closed 52. The six containers on the right side of the FIG. 3x2) are all showing the second color 48, which indicates that the valves of these containers are all open 50. The visual indication greatly improves on the time required to check each and every valve of the containers. This also provides visual information as to whether the containers are ready to ship or not.

Still additional benefits include high levels of confidence in the knowledge that the valves are open/closed by simple addition of the apparatus 30 on the drains of the containers. As the size of the apparatus portions are different, the apparatus cannot be placed the wrong way as the second portion of the apparatus will not fit when the valve is open.

Still further, when the drains include cam locks, the apparatus fits over the ears of the locks to mitigate opening of the valves by way of the cam locks coming undone. Thus, the apparatus also provides a sort of locking mechanism to further improve on the safety of the devices.

Therefore, the apparatus as shown and/or described provides a secondary check to mitigate shipping or filling an open container. This mitigates loss of containment and improves the confidence of the use of the containers. The use of the apparatus also mitigates bending over of individuals to determine valve status, improving the ergonomic benefits of employees. The use of the color coding can allow for assessment from a distance of the valves of the containers.

Therefore, the safety apparatus provided has been shown to have numerous benefits. Still further, it should be noted that, while containers are identified, it should be noted that the apparatus could be used with any sort of container that includes an outlet drain and valve to control the openness thereof. In addition, it is envisioned that the apparatus could be a one time use or multi use device. Still other changes, variations, alternatives, or the like are to be considered a part of the present disclosure and are considered obvious thereto. Any of the aspects of any of the embodiments herein could be combined in ways not explicitly shown or described to result in yet additional embodiments that are to be considered a part of the present disclosure.

1. A visual apparatus for indicting if a valve of a container is open or closed, comprising:
a cylindrical body having a first portion having a first outer diameter and a second portion extending from the first portion and having a second outer diameter;
wherein the first outer diameter is less than the second outer diameter; and
wherein the second portion of the cylindrical body is unable to be positioned on the valve of the container when the valve is open.

2. The visual apparatus of claim 1, wherein the first portion faces outward from the container when the valve of the container is closed.

3. The visual apparatus of claim 1, wherein the second portion faces outward from the container when the valve of the container is open.

4. The visual apparatus of claim 1, wherein the first portion comprises a first color, and at least a face of the second portion comprises a second color.

5. The visual apparatus of claim 4, wherein the face and an outer portion of the second portion comprise the second color.

6. The visual apparatus of claim 4, wherein the second color comprises red.

7. The visual apparatus of claim 1, wherein the first and second portions of the cylindrical body comprise a common inner diameter.

8. The visual apparatus of claim 1, wherein the first and second portions are coaxial.

9. The visual apparatus of claim 1, wherein the cylindrical body comprises a rigid polymer.

10. In combination, a container and a visual apparatus, the combination comprising:
the container comprising a body for holding a liquid and a drain valve that is used to drain liquid from the container, the valve comprising an arm to open and close the valve; and
the visual apparatus comprising a cylindrical body having a first portion having a first outer diameter and a second portion extending from the first portion and having a second outer diameter;
wherein the first outer diameter is less than the second outer diameter; and
wherein the second portion of the cylindrical body is unable to be positioned on the valve of the container when the valve is open.

11. The combination of claim 10, wherein the first portion of the visual apparatus faces outward from the container when the valve of the container is closed.

12. The combination of claim 10, wherein the second portion of the visual apparatus faces outward from the container when the valve of the container is open.

13. The combination of claim 10, wherein the first portion of the visual apparatus comprises a first color, and at least a face of the second portion of the visual apparatus comprises a second color.

14. The combination of claim 13, wherein the second color comprises red.

15. The combination of claim 10, wherein the first and second portions of the cylindrical body comprise a common inner diameter.

16. The combination of claim 10, wherein the first and second portions are coaxial.

17. A method of providing a visual determination as to the status of a valve of a container, the method comprising:
positioning a visual apparatus on the valve, wherein the visual apparatus comprises a cylindrical body having a first portion having a first outer diameter and a second portion extending from the first portion and having a second outer diameter;
wherein the visual apparatus fits on the valve with the second portion facing away from the valve when the valve is open and wherein the visual apparatus fits on the valve with the first portion facing away from the valve when the valve is closed.

18. The method of claim 17, wherein the second portion of the visual apparatus comprises a different color than the first portion.

19. The method of claim 18, wherein the color viewed indicates the status of the valve of the container.

20. The method of claim 17, wherein the step of positioning the visual apparatus on the valve comprises moving the visual apparatus around the valve with the portion of the visual apparatus determined by the position of an arm of the valve.
